(19) United States
(12) Patent Application Publication
(10) Pub. No.: US 2004/0154242 A1
(43) Pub. Date: Aug. 12, 2004

(54) Fabric storm cover for an opening in a building

(75) Inventors: Mark S. Hudoba, Gulf Breeze, FL (US); Ben Chen, Pensacola, FL (US)

Correspondence Address: Phillip L. Kenner, RENNER, KENNER, GREIVE,, BOBAK, TAYLOR & WEBER, First National Tower, Fourth Floor, Akron, OH, 44308-1456, US

(73) Assignee: WAYNE-DALTON CORP.

(21) Appl. No.: 10/358,944

(22) Filed: Feb. 5, 2003

(51) Int. Cl. E06B 3/26

(52) U.S. Cl. 52/202

(57) ABSTRACT

A system (10) for covering an opening (11) in a structure (12) includes a sheet (13) of flexible material having opposed side edges (16, 17). A thickened area (18) and a pocket (20) are formed at the side edges (16, 17). A plurality of spaced apertures (22) extend through the thickened area (18), and a rope (21) is positioned in the pocket (20). A grommet assembly (23) is positioned in each of the apertures (22) to reinforce the apertures (22). A plurality of fasteners (28) are carried by the structure (12) and are spaced so that they can extend through the apertures (22). Wing nuts (34) received by the fasteners (28) hold the sheet (13) on the structure (12) and over the opening (11).

### TECHNICLA FIELD

This invention relates to a device for covering an opening in a structure, such as a window, door or the like, to protect the structure's envelope from being breached by impact from high velocity wind loads or by impact from debris or other objects which might be airborne because of such winds. More particularly, this invention relates to such a device which is in the form of a fabric panel which can easily be attached to the structure.

### BACKGROUND ART

Extreme weather-created phenomenon, such as hurricanes, typhoons, tornadoes, or the like can often cause damage to building structures. Such storm-related damage frequently occurs when high winds, and/or debris carried thereby, invade the structure through its weakest points, typically its window or door openings. Once invaded, the structure is vulnerable to further damage to the interior thereof, and thus, particularly in geographic areas susceptible to frequent violent weather conditions, it is important to protect the weakest portions of a structure, at least the windows and the doors, with some type of covering.

Most traditionally, home or building owners, if alerted to an oncoming storm, cover these portions of their structures by nailing plywood or other boards over them. However, this “boarding up” procedure is not only time consuming, when time is usually of the essence, but also such can disfigure the exterior of the structure upon the frequent installation and removal of the boards. In addition, the plywood or other boards are not only heavy and cumbersome to move, but also they will eventually deteriorate, and after frequent use, their fastening points are no longer effective. Moreover, storing or maintaining an inventory of the boards can take up a great deal of space which would otherwise be usable for other purposes.

As a result, a number of temporarily installable or permanently installed devices have been developed. However, in general, these devices are expensive, difficult to install or disassemble, and cumbersome to store. Furthermore, those which are not stored but rather which are permanent fixtures for the structure usually do not add aesthetic value to the structure but rather detract therefrom. For example, some of these devices are in the form of shutters which include rolled-up slatted material which must be rolled down, either manually or automatically by a motor, which increases the cost thereof. Alternatively, metallic panels, such as those made out of aluminum or steel, may be specially designed for each structure opening to be protected and mounted to the wall of the structure on a special frame. At times, a LEXAN® type of material has been substituted for the metallic portion of the device. However, all of these alternatives are rigid, heavy, cumbersome to store, quite expensive, not aesthetically pleasing, and, particularly in the case of the LEXAN® material, do not weather well.

Other alternatives to these shutter-like devices are fabric screen-based systems. These systems, while less expensive than their counterparts, are often quite large and difficult to install. Usually, they are attached to an overhang or an eave and must be positioned at a distance in excess of two feet from the window or door to be protected. They must be specially designed for each such item to be covered, dependent on the nature of the item and its location relative to an overhang or an eave, and they present installation and storage issues.

Thus, the need exists for a system to protect openings in a building structure which does not suffer the drawbacks discussed above.

### DISCLOSURE OF THE INVENTION

It is thus an object of the present invention to provide a system for covering an opening in a building structure, such as a window or a door, to protect the opening and the internal portion of the structure from invasion during a storm or the like.

It is another object of the present invention to provide a system, as above, which includes a fabric sheet that need not be substantially spaced from the opening.

It is a further object of the present invention to provide a system, as above, in which no special tensioning provisions for the fabric need be provided.

It is an additional object of the present invention to provide a system, as above, which is not unsightly and which does not include any components which might corrode or otherwise deteriorate.

It is yet another object of the present invention to provide a system, as above, which is lightweight, easy to store and to install, and which is inexpensive.

It is a still further object of the present invention to provide a system, as above, which can pass the testing standards established by most governmental authorities.

These and other objects of the present invention, as well as the advantages thereof over existing prior art forms, which will become apparent from the description to follow, are accomplished by the improvements hereinafter described and claimed.

In general, a system for covering an opening in a structure made in accordance with one aspect of the invention includes a sheet of flexible material having at least one set of opposed edges. The set of opposed edges is provided with a thickened area, and a plurality of spaced, reinforced openings are formed through the thickened area in each opposed edge.

In accordance with another aspect of the invention, a sheet of flexible material has a plurality of spaced apertures formed near two of its opposed edges. A grommet assembly is provided for each aperture to reinforce each aperture, and a rope is carried by the sheet and is positioned near each edge adjacent to the apertures.

In another aspect of the present invention, a sheet of flexible material is provided with a thickened area at two of its opposed edges. A plurality of spaced apertures extend through the thickened area, and a rope is positioned at both edges adjacent to the apertures.

A preferred exemplary system for covering an opening in a structure incorporating the concepts of the present invention is shown by way of example in the accompanying drawings without attempting to show all the various forms and modifications in which the invention might be embodied, the invention being measured by the appended claims and not be the details of the specification.

### BRIEF DESCRIPTION OF THE DRAWINGS

FIG. 1 is an exploded perspective view of the system of the present invention showing the manner in which it is adapted to cover an opening in a structure.

FIG. 2 is an enlarged, exploded, fragmentary perspective view of a portion of that which is shown in FIG. 1.

FIG. 3 is a view similar to FIG. 2 but showing the components thereof partially assembled.

FIG. 4 is a sectional view taken substantially along line 4-4 of FIG. 2.

FIG. 5 is a view similar to FIG. 4 but showing the components thereof assembled.

FIG. 6 is a view similar to FIG. 5 but showing the system fully attached to the structure.

### PREFERRED EMBODIMENT FOR CARRYING OUT THE INVENTION

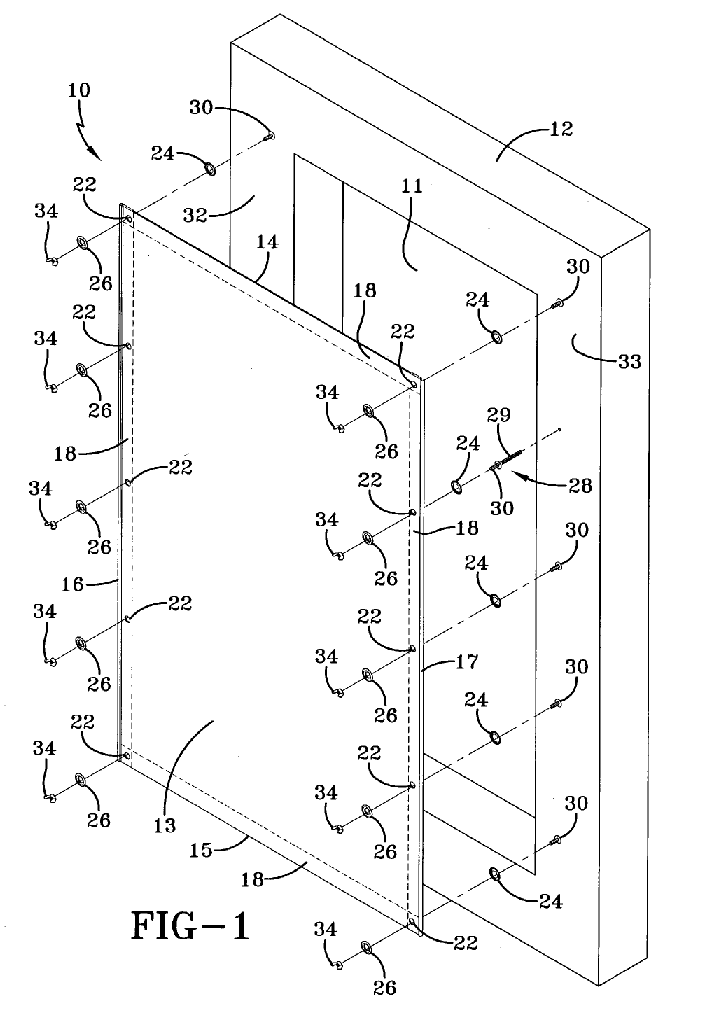

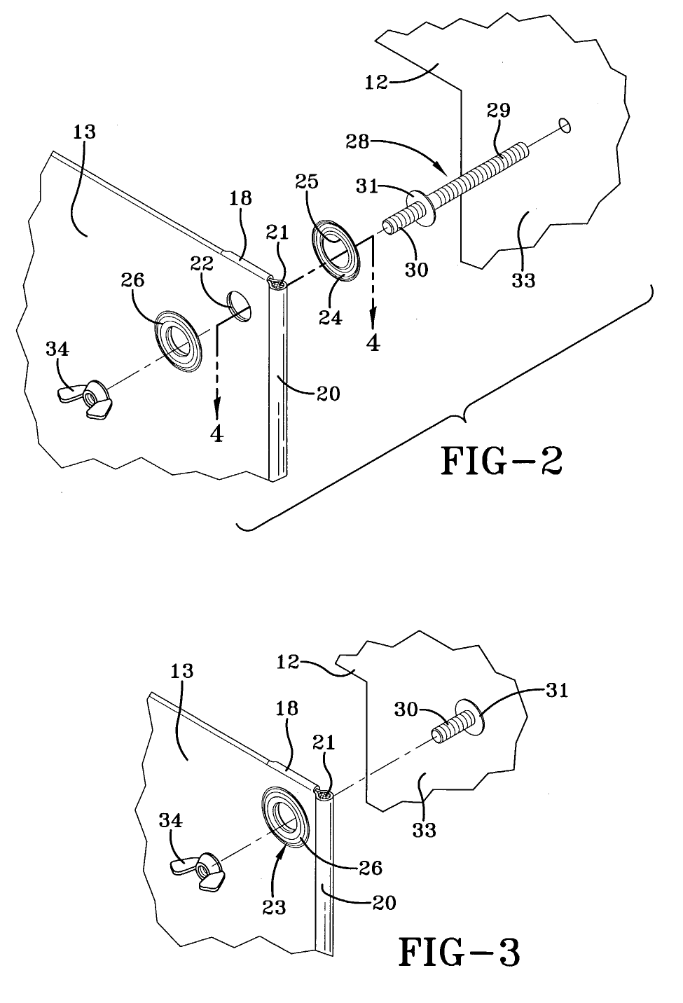

A system, generally indicated by the numeral 10, is shown in FIG. 1 as being adapted to cover an opening 11, such as a window, door or the like, in a building structure 12. System 10 includes a sheet 13 of flexible material which is shown to be generally rectangular in nature having two sets of opposed edges, that is, an upper edge 14 and an opposed lower edge 15, and opposed side edges 16 and 17. Sheet 13 is preferably formed of a vinyl- or urethane-coated, woven nylon or polyester fabric, more specific details of such being hereinafter described.

At least side edges 16 and 17, and potentially edges 14 and 15 as well, may be provided with a thickened area 18. Thickened area 18 may be formed in several different manners. For example, a strip of material may be attached to the edges 14-17 of sheet 13, or preferably, as shown, the edges may be folded back on themselves to form a second layer or hem 19 of material. The layer 19 may then be attached to sheet 13 by any suitable method, as by sewing, heat welding, gluing or the like. When forming thickened area 18 in this manner, a pocket 20 is preferably formed to define the outer lateral extents of sheet 13. A rope 21 or equivalent device may be received in each pocket 20 and fixed therein, as by heat welding or the like.

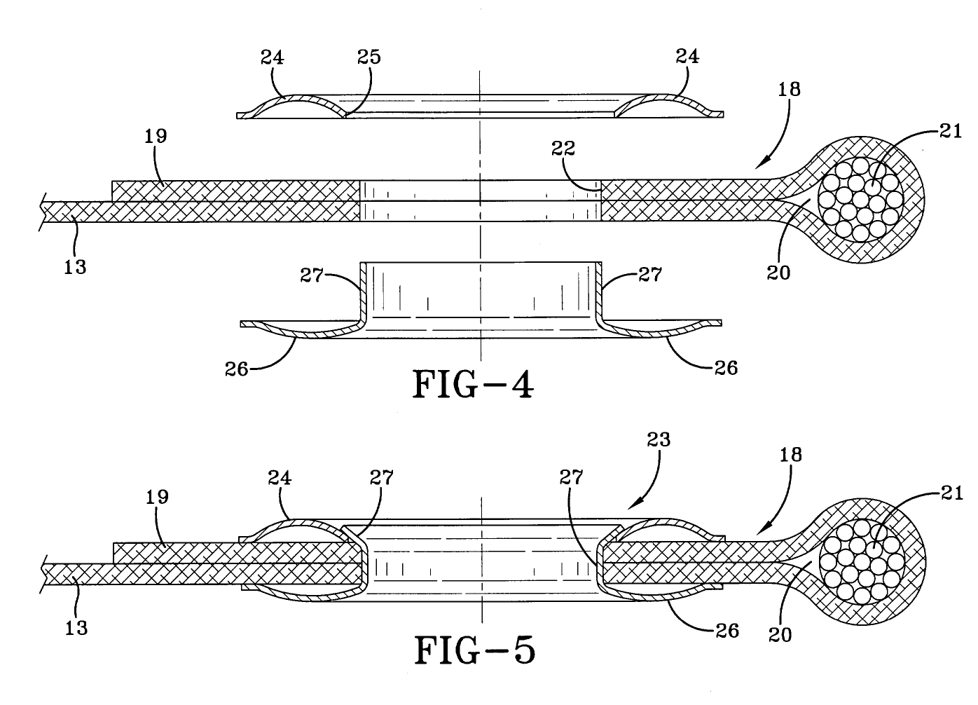

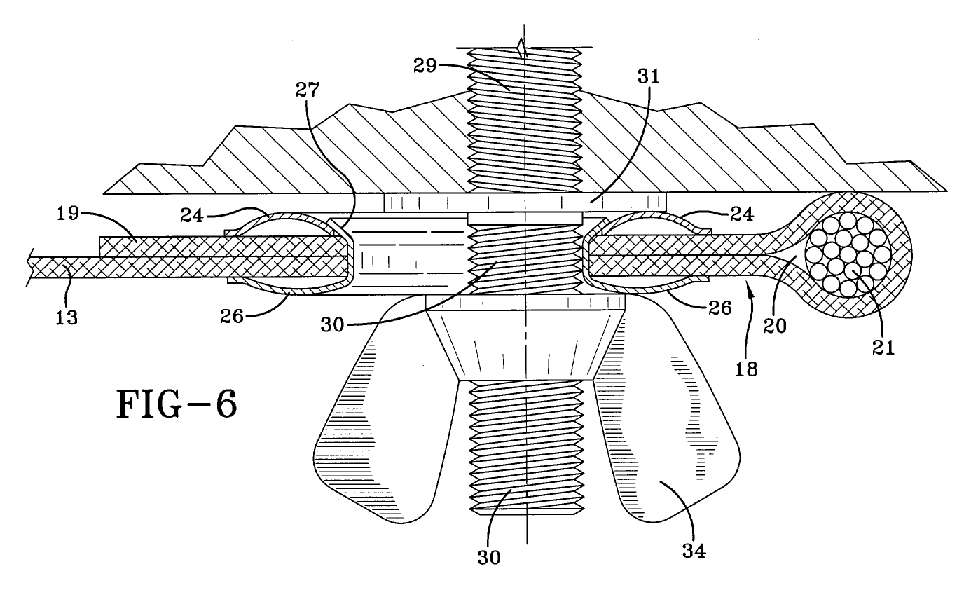

A plurality of spaced openings or apertures 22 are formed through the thickened area 18 of at least one of the two sets of opposed edges, such as opposed side edges 16 and 17, as shown. As best shown in FIGS. 4 and 5, each aperture 22 is reinforced by a grommet assembly, generally indicated by the numeral 23, or similar device. Each grommet assembly 23 includes a washer plate 24 positioned on one side of sheet 13. Washer plate 24 has an aperture 25 alignable with sheet aperture 22. Grommet assembly 23 also includes a grommet plate 26 positioned on the other side of sheet 13. Grommet plate 26 includes a hollow, generally cylindrical shank 27 which is received through aperture 22 of sheet 13 and through aperture 25 of plate 24. When so positioned, shank 27 may be crimped over the internal circular edge of plate 24, as shown in FIG. 5, to affix grommet assembly 23 to sheet 13 thereby reinforcing each aperture 22.

In order to attach system 10 to building structure 12, a plurality of fasteners, generally indicated by the numeral 28, are preferably provided. While fasteners 28 may be of any conventional type, they should be of the type which may be easily, and potentially permanently if desired, positioned in structure 12, and at the same time, provide for easy and quick attachment of fabric sheet 13 thereto. To that end, the preferred fastener 28 is one which has two sets of threads 29 and 30 separated by a generally circular flange 31, as best shown in FIG. 2. Fasteners 28 are thus inserted into structure 12 and held thereto by threads 29 with flange 31 preferably abutting the surface of structure 12.

If sheet 13 is provided with reinforced apertures 22 spaced along the side edges 16 and 17 thereof, as shown, fasteners 28 are positioned in the faces 32 and 33 of structure 13 at the sides of opening 11 and are spaced from each other in each face 32 and 33 a distance generally equal to the distance between apertures 22 in edges 16 and 17, respectively. However, the distance between the opposed fasteners 28 in faces 32 and 33 could be slightly more than the distance between opposed apertures 22 in edges 16 and 17 of sheet 13. Such provides a slight tensioning of the fabric material 13 upon installation of system 10 on structure 12, as now to be described.

Once fasteners 28 are mounted in structure faces 32 and 33, to install a fabric sheet 13, one need only position the grommet-reinforced apertures 22 over threaded portion 30 of fasteners 28. If, as described above, the distance between opposed fasteners 28 in faces 32 and 33 is more than the distance between the opposed apertures 22 in edges 16 and 17, such action will automatically tension sheet 13. Then, conventional wing nuts 34, or like components, may be threaded onto threads 30 of fasteners 28 and fully tightened to hold sheet 13 in place.

When installed, fabric material 13 is sufficiently strong to withstand the impact of high winds and debris without failure. In this regard, the preferred coated fabric, as previously described, has been found to pass conventional test standards as promulgated, for example, by ASTM by Southern Building Code Congress International and by Dade County, Fla. These tests require that the fabric withstand the force of a nine pound two-by-four impacting the sheet at fifty feet per second. In addition to the type of material involved, it is primarily the tensile strength and elongation factors, or combinations thereof, of the fabric which enable the fabric to pass the tests. In this regard, a preferred fabric should have a tensile strength of greater than 460 pounds, in both the warp and fill directions, and an elongation, at failure, of approximately 50 percent in both directions. More specifically, the combination of tensile strength and elongation, when multiplied together, should be greater than 230 pounds.

If extreme conditions should cause even the grommet-reinforced apertures 22 of the preferred fabric material 13 to begin to tear, total failure is prevented by the presence of ropes 21 at the lateral periphery of sheet 13. That is, fasteners 28 cannot tear through the edges 16 and 17 of the sheet 13 because they would engage rope 21 which would resist the tearing.

In view of the foregoing, it should thus be evident that a system for covering an opening in a structure, to protect the opening and the structure from damage created by high winds and/or airborne debris, constructed and installed as described herein, accomplishes one or more objects of the present invention and otherwise substantially improves the art.

What is claimed is:

1. A system for covering an opening in a structure comprising a sheet of flexible material having at least one set of opposed edges, said opposed edges being provided with a thickened area, and a plurality of spaced reinforced openings formed through said thickened area in each opposed edge.

2. The system of claim 1 further comprising a pocket formed at each said opposed edge.

3. The system of claim 2 wherein said thickened area and said pocket are formed by folding each edge of said sheet back on itself to form two layers of said material, said layers being attached to each other.

4. The system of claim 2 further comprising a rope positioned in each said pocket.

5. The system of claim 4 wherein said rope is attached to said pocket.

6. The system of claim 1 wherein said openings are reinforced by a grommet assembly.

7. The system of claim 6 wherein each said grommet assembly includes a washer plate on one side of said sheet and a grommet plate on the other side of said sheet.

8. The system of claim 7 wherein said washer plate has an aperture aligned with said opening and said grommet plate includes a shank received through said opening and said aperture and crimped to engage said washer plate.

9. The system of claim 1 further comprising a plurality of spaced fasteners adapted to be carried by the structure on opposed sides of the opening in the structure, the spacing between said fasteners on each opposed side of the opening being generally the same as the spacing of said reinforced openings in each opposed edge.

10. The system of claim 9 wherein the spacing between said fasteners on one side of the opening in the structure and said fasteners on the other side of the opening in the structure is slightly more than the spacing between said reinforced openings on one said edge and said reinforced openings on said opposed edge.

11. The system of claim 9 wherein said fasteners include a first set of threads adapted to engage the structure and a second set of threads received through said reinforced openings.

12. The system of claim 11 further comprising a nut engaging said second set of threads.

13. The system of claim 1 wherein said sheet of flexible material includes a woven base fabric coated with a plastic material.

14. The system of claim 13 wherein said sheet of flexible material has a tensile strength expressed in pounds and an elongation at failure expressed in percentages which when multiplied together exceeds approximately 230 pounds.

15. A system for covering an opening in a structure comprising a sheet of flexible material having two opposed edges, a plurality of spaced apertures near both said edges, a grommet assembly for each said aperture to reinforce said apertures, and a rope carried by said sheet and positioned near each said edge adjacent to said apertures.

16. The system of claim 15 wherein a thickened area is formed in each said edge, said thickened areas being formed by folding each said edge of said sheet back on itself to form two layers of said material, said layers being attached to each other, and said apertures extending through said layers.

17. The system of claim 16, a pocket being formed at each said edge when said sheet is folded back on itself, said pocket carrying said rope.

18. A system for covering an opening in a structure comprising a sheet of flexible material having two opposed edges, said opposed edges being provided with a thickened area, a plurality of spaced apertures near both said edges extending through said thickened area, and a rope positioned at both said edges adjacent to said apertures.

19. The system of claim 18 further comprising a grommet assembly for each said aperture to reinforce each said aperture.

20. The system of claim 18 wherein said thickened areas are formed by folding each said edge of said sheet back on itself to form two layers of said material, said layers being attached to each other.

21. The system of claim 20, a pocket being formed at each said edge when said sheet is folded back on itself, said pocket carrying said rope.

22. A system for covering an opening in a structure comprising a sheet of flexible material having at least one set of opposed edges, said opposed edges being provided with a thickened area, a plurality of spaced apertures formed through said thickened area in each said edge, a grommet assembly for each said aperture to reinforce said apertures, and a rope carried by said sheet and positioned near each said edge adjacent to said apertures.
